(19) United States
(12) Patent Application Publication
(10) Pub. No.: US 2025/0157178 A1
(43) Pub. Date: May 15, 2025

(54) EARLY FUSION OF NEURAL RAY GRAPH NETWORKS FOR MULTI-VIEW CAMERA SETUPS

(71) Applicant: QUALCOMM Incorporated, San Diego, CA (US)

(72) Inventors: Varun Ravi Kumar, San Diego, CA (US); Senthil Kumar Yogamani, Headford (IE); Sweta Priyadarshi, San Diego, CA (US)

(21) Appl. No.: 18/506,507

(22) Filed: Nov. 10, 2023

(51) Int. Cl. G06V 10/44; G06T 7/80

(52) U.S. Cl. CPC G06V 10/44; G06T 7/80; G06V 2201/07

(57) ABSTRACT

This disclosure provides systems, methods, and devices for vehicle driving assistance systems that support image processing. In a first aspect, an image processing method includes receiving image frames; determining an ordered set of neural rays based on the image frames; determining a graph network that represents each neural ray of the ordered set of neural rays as a sequence of points; and determining a feature set based on the graph network. Each neural ray of the ordered set of neural rays represents three-dimensional positions of pixels of an image frame. Each point on the graph network is associated with a node of a plurality of nodes of the graph network. The feature set includes features of each of the image frames. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection. Various driving, or movement, assistance systems have also been produced in machine automation generally, such as in robotics.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road. Aspects of this disclosure also provide improved systems for assisting users of non-vehicle systems such as robotics.

Example embodiments provide a unified representation of all of the information captured by the different cameras of a multi-camera setup. The unified representation is determined by early fusion of images, received from the cameras of the multi-camera setup, that are represented as neural rays. As used herein, early fusion refers to images being fused prior to image features being passed to an encoder.

In some embodiments, each pixel of each image captured by a camera of the multi-camera setup may be projected as a point on a 3D space. Starting from the camera's center as the origin and moving away from the origin in the 3D space, a set of these points represents a neural ray. In this way, a plurality of neural rays are created representing the images captured by the cameras of the multi-camera setup. The neural rays may be organized into an ordered set based on a parameter. For example, the neural rays may be ordered by azimuth angle. A graph network (e.g., a graph neural network) may be created that represents each of the ordered neural rays as a sequence of points such that each point is a node in the graph network. Edges are determined in the graph network based on spatial proximity between two nodes. Based on the constructed graph network, a feature set can be determined that includes features of each of the image frames. For example, the feature set may be determined by applying graph attention networks (GAT) to the constructed graph network. In such an example, the GAT operation allows for the node representations to be updated in a graph-specific manner by taking into account the internode relationships encoded in the graph network structure. The resulting node features of the feature set can thereafter be provided to a ray encoder-decoder network. In this way, the present techniques provide a simpler and more efficient approach to 3D object detection that can also improve the 3D object detection.

While the present techniques are primarily described for use in a vehicle assistance system, one having ordinary skill in the art will appreciate how the present techniques can be implemented with other machine control-assistance systems or automation systems generally. For example, the present techniques may be implemented with various robotic systems to improve the control-assistance system or automation system of the robotic system.

In one aspect of the disclosure, a method for image processing includes receiving a plurality of image frames; determining an ordered set of neural rays based on the plurality of image frames; determining a graph network that represents each neural ray of the ordered set of neural rays as a sequence of points; and determining, based on determining the graph network, a feature set for processing by a transformer network. Each neural ray of the ordered set of neural rays represents three-dimensional positions of pixels of an image frame of the plurality of image frames, each point is associated with a node of a plurality of nodes of the graph network, and the feature set includes features of each of the plurality of image frames.

In an additional aspect of the disclosure, an apparatus includes at least one processor and a memory coupled to the at least one processor. The at least one processor is configured to perform operations including receiving a plurality of image frames; determining an ordered set of neural rays based on the plurality of image frames; determining a graph network that represents each neural ray of the ordered set of neural rays as a sequence of points; and determining, based on determining the graph network, a feature set for processing by a transformer network. Each neural ray of the ordered set of neural rays represents three-dimensional positions of pixels of an image frame of the plurality of image frames, each point is associated with a node of a plurality of nodes of the graph network, and the feature set includes features of each of the plurality of image frames.

In an additional aspect of the disclosure, a non-transitory computer-readable medium stores instructions that, when executed by a processor, cause the processor to perform operations. The operations include receiving a plurality of image frames; determining an ordered set of neural rays based on the plurality of image frames; determining a graph network that represents each neural ray of the ordered set of neural rays as a sequence of points; and determining, based on determining the graph network, a feature set for processing by a transformer network. Each neural ray of the ordered set of neural rays represents three-dimensional positions of pixels of an image frame of the plurality of image frames, each point is associated with a node of a plurality of nodes of the graph network, and the feature set includes features of each of the plurality of image frames.

In an additional aspect of the disclosure, a vehicle includes a plurality of cameras that together have a field of view spanning around the vehicle, at least one processor, and a memory coupled to the at least one processor. The at least one processor is configured to perform operations including receiving, from the plurality of cameras, a plurality of image frames; determining an ordered set of neural rays based on the plurality of image frames and intrinsic parameters of the plurality of cameras; determining a graph network that represents each neural ray of the ordered set of neural rays as a sequence of points; and determining, based on determining the graph network, a feature set for processing by a transformer network. Each neural ray of the ordered set of neural rays represents three-dimensional positions of pixels of an image frame of the plurality of image frames, each point is associated with a node of a plurality of nodes of the graph network, and the feature set includes features of each of the plurality of image frames.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating an example system for determining feature set according to one or more aspects of the disclosure.

FIG. 5 depicts image sensor configurations for a vehicle according to one or more aspects of the disclosure.

FIG. 6 is a flow diagram illustrating an example pipeline for early fusion of images received from a multi-camera setup according to one or more aspects of the disclosure.

FIG. 7 is a flow chart illustrating an example method for early fusion of images received from a multi-camera setup according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support early fusion of images, received from a multi-camera setup, that are represented as neural rays to determine a single unified representation of all the images received from the multi-camera setup. As used herein, early fusion refers to images being fused prior to image features being passed to an encoder. A typical setup for a vehicle with driving assistance includes an array of multiple cameras each having a field-of-view that when combined as a whole encompass a field-of-view of 360 degrees around the vehicle. For example, the array may include four short-range cameras (e.g., fisheye lens cameras) and six to eight long-range cameras (e.g., pinhole lens cameras). Typical techniques involve handling the information received from each camera independently in combining the information at the output level. In some instances, however, information (e.g., an object) can be split across different images captured by different cameras of the array. The present techniques provide synergy between the different cameras in such instances by determining a unified representation of all of the information captured by the different cameras. For instance, the present techniques provide the ability to fuse raw pixel data from multiple camera views into an ordered 3D graph-based representation that preserves full details and 3D relationships for improved learning and inference, which can provide a strong foundation for downstream 3D perception tasks.

Each pixel of each image captured by a camera of the multi-camera setup may be projected as a point on a 3D space. Starting from the camera's center as the origin and moving away from the origin in the 3D space, a set of these points represents a neural ray. In this way, a plurality of neural rays are created representing the images captured by the cameras of the multi-camera setup. The neural rays may then be organized into an ordered set based on a parameter. For example, the neural rays may be ordered by azimuth angle. After the ordered set of neural rays is determined, a graph network (e.g., a graph neural network) may be created that represents each neural ray as a sequence of points such that each point is a node in the graph network. Edges are determined in the graph network based on spatial proximity between two nodes. The graph network representation of the neural rays allows modeling the spatial relationships between points on different rays. Based on the constructed graph network, a feature set can be determined that includes features of each of the image frames that are represented by the ordered set of neural rays. For example, the feature set may be determined by applying graph attention networks (GAT) to the constructed graph network. In such an example, the GAT operation allows for the node representations to be updated in a graph-specific manner by taking into account the internode relationships encoded in the graph network structure. The resulting node features of the feature set can thereafter be provided to a ray encoder-decoder network.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the present techniques provide a simpler and more efficient approach to 3D object detection that can also improve the 3D object detection. For instance, by utilizing early fusion, the present techniques preserve all information from the cameras as the neural rays are unprojected directly from the camera images. Preserving all of the information can be particularly advantageous in cases where the object of interest is small and difficult to detect using typical feature extraction methods. Early fusion also enables a compact and structured representation of a scene by reducing the number of parameters needed to be learned as compared to typical convolutional neural networks because the neural rays can be represented as a fixed set of 3D coordinates, which can be more effectively processed by subsequent modules, such as a graph neural network.

In addition, creating neural rays and structuring the neural rays as a graph network using graph neural networks enables the present techniques to determine a more expressive and accurate representation of the 3D environment as compared to using birds-eye-view (BEV) features. For example, neural rays capture richer and more detailed information about the scene than BEV features and structuring the neural rays as a graph network enables a deep learning model to reason about the relationships between different parts of the scene in a more structured and flexible way. Additionally, the use of graph neural networks in the present techniques allows for end-to-end learning of the feature representations. The improved feature generation using the provided techniques improves the accuracy of downstream perception tasks that utilize these features to provide vehicle assistance services. In particular, these techniques may enable more accurate tracking of vehicles, pedestrians, obstacles, road signage, road markings, and the like.

One benefit of improved tracking is that it allows vehicle control systems to more accurately navigate vehicles around obstacles. This can be particularly useful in situations where there may be unexpected obstructions or road conditions that could pose a hazard to drivers. Additionally, improved tracking can help to improve overall safety on the roads by reducing vehicle collisions. With better tracking capabilities, vehicles can be made more responsive to nearby obstacles and can be routed around detected obstacles more efficiently. These improvements can also extend to driver assistance systems, which can benefit from increased monitoring capabilities. By expanding the number, type, and variety of surrounding objects that can be detected, these systems can offer more accurate alerts and assistance to drivers when necessary, without generating unnecessary notifications or distractions.

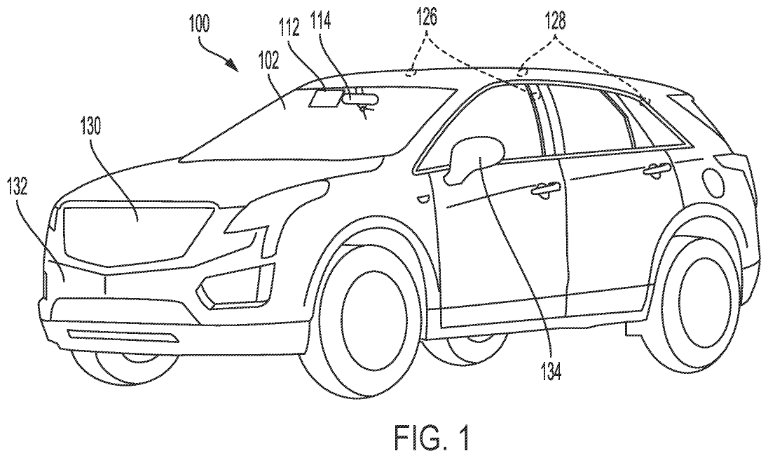

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to determine an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

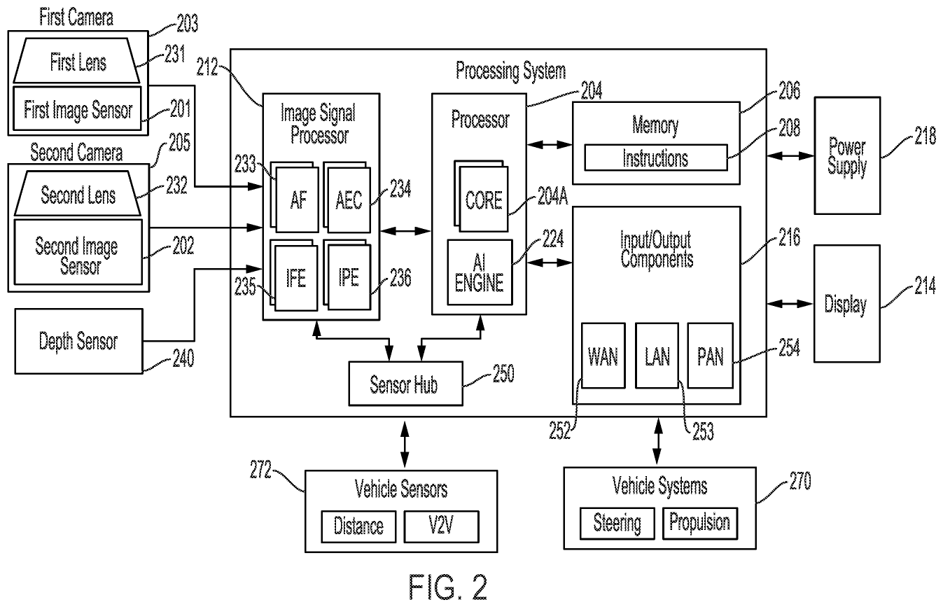

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to determine motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in determined motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to determine images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

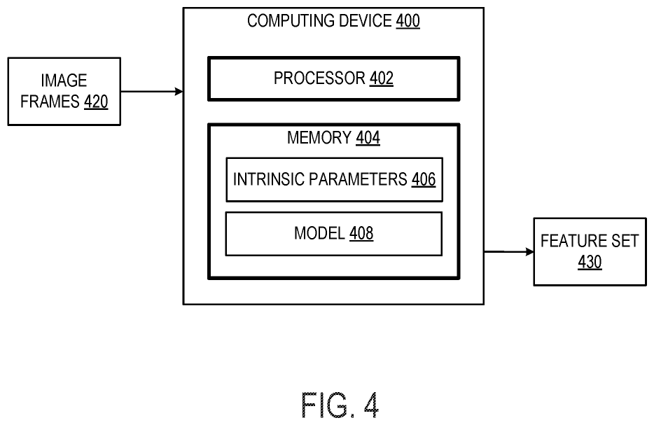

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination). The accuracy of the output of commands to the vehicle systems 270 may be improved according to embodiments of this disclosure by using one or more machine learning models, such as that described in connection with FIG. 4, to determine an improved representation of all of the information captured by the different cameras of a multi-camera setup, which can affect the commands sent to the vehicle systems 270.

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

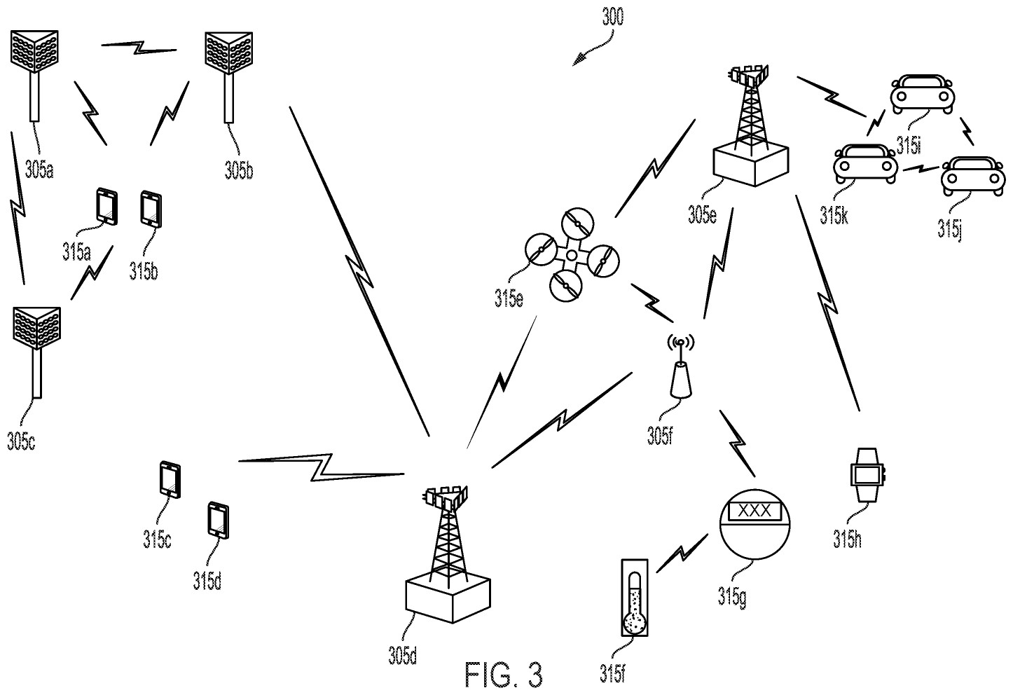

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (COMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315c include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305c.

Aspects of the vehicular systems described with reference to, and shown in, FIG. 1, FIG. 2, and FIG. 3 may include projecting each pixel of each image captured by a camera of the multi-camera setup as a point on a 3D space. A neural ray is created as a set of these points that form a ray extending away from the camera's center as the ray's origin. In this way, a plurality of neural rays are created representing the images captured by the cameras of the multi-camera setup. The neural rays may be organized into an ordered set based on a parameter. For example, the neural rays may be ordered by azimuth angle. A graph network (e.g., a graph neural network) may be created that represents each of the ordered neural rays as a sequence of points such that each point is a node in the graph network. Edges are determined in the graph network based on spatial proximity between two nodes. Based on the constructed graph network, a feature set can be determined that includes features of each of the image frames that are represented by the ordered set of neural rays. The resulting node features of the feature set can thereafter be provided to a ray encoder-decoder network.

FIG. 4 is a block diagram illustrating an example computing device 400 that can determine a feature set 430 based on a plurality of image frames 420. The image frames 420 may be received from a plurality of cameras, and more particularly from the respective image sensors of the plurality of cameras. In various instances, an object (e.g., a truck) in a scene may span across two or more of the image frames 420. For example, a first portion of the object may be depicted in a first image frame and a second portion of the object may be depicted in a second image frame. In various instances, a portion of an object in the scene may be depicted in both the first image frame and the second image frame. For example, two cameras may have overlapping fields-of-view such that both cameras capture the same portion of the object.

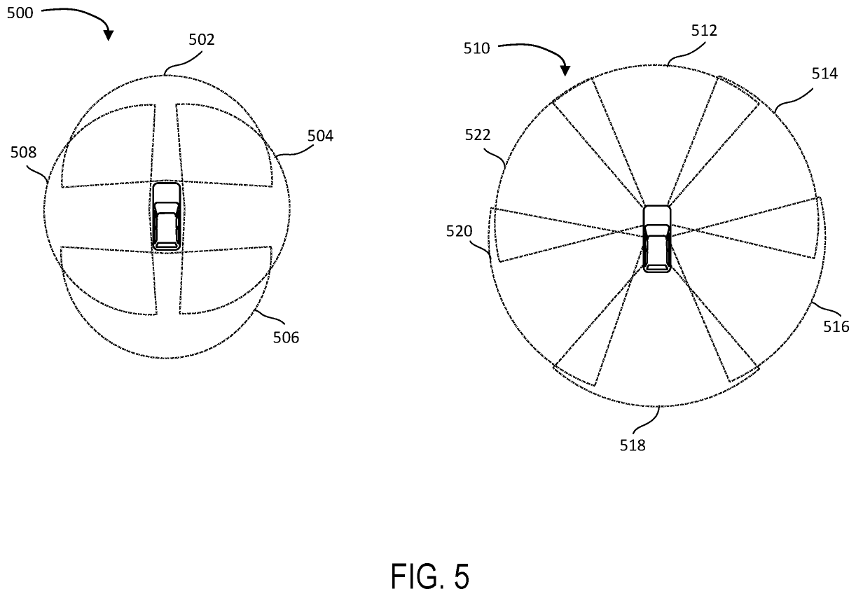

In various aspects, the image frames 420 together as a whole represent an entire 360 degree area surrounding a vehicle. For example, FIG. 5 depicts image sensor configurations 500, 510 for a vehicle (e.g., vehicle 100) that are able to capture a 360 degree area surrounding the vehicle 100 according to an exemplary embodiment of the present disclosure. The first image sensor configuration 500 shows a potential arrangement of near-field image sensors 502, 504, 506, 508 with a field of view of 180 degrees. In particular, the first configuration 500 utilizes four near-field image sensors to visually cover an area surrounding the vehicle. In an example, first image sensor 201 may be one of near-field image sensors 502, 504, 506, 508. The second image sensor configuration 510 shows a potential arrangement of far-field image sensors 512, 514, 516, 518, 520, 522 with a field of view of approximately 70 degrees. In particular, the second configuration 510 utilizes six far-field image sensors to visually cover an area surrounding the vehicle. In an example, second image sensor 202 may be one of far-field image sensors 512, 514, 516, 518, 520, 522. As can be seen in the configurations 500, 510, certain areas may be covered by more than one image sensors. For example, image sensors 502 and 504 have partially overlapping areas and image sensors 512, 514 have partially overlapping areas. Similarly, image sensors of different types may overlap. For example, a single vehicle may be equipped with both near-field image sensors 502, 504, 506, 508 arranged as shown for the configuration 500 and far-field image sensors 512, 514, 516, 518, 520, 522 as shown for the configuration 510. In such instances, certain near-field and far-field image sensors may have overlapping areas (such as the image sensor 502 and the image sensors 512, 514).

Returning to FIG. 4, computing device 400 may be implemented by the image processing configuration of FIG. 2 or by one or more of the components illustrated in FIG. 3. Computing device 400 includes a processor 402 (e.g., processor 204) coupled to a memory 404 (e.g., memory 206). In various aspects, processor 402 may include more than one processor. For example, processor 402 may include a first processor 402A (not shown) and a second processor 402B (not shown) that are each coupled to the memory 404. The first processor 402A may be in communication with the second processor 402B. The first processor 402A and the second processor 402B may each perform all of the operations performed by processor 402, or alternatively, the first processor 402A may only perform a first portion of the operations and the second processor 402B may only perform a second portion of the operations. In various aspects, memory 404 may include more than one memory. For example, memory 404 may include a first memory 404A (not shown) and a second memory 404B (not shown) that are each coupled to processor 402. The first memory 404A and the second memory 404B may each store all of the processor-executable code for all of the operations of processor 402, or alternatively, the first memory 404A may only store a first portion of the processor-executable code and the second memory 404B may only store a second portion of the processor-executable code. In another example, processor 402 may include the first processor 402A and the second processor 402B that are each coupled to a first memory 404A (not shown) and a second memory 404B (not shown) of memory 404. In another example, processor 402 may include the first processor 402A coupled to the first memory 404A of memory 404, but not to the second memory 404B of memory 404, and the second processor 402B coupled to the second memory 404B, but not to the first memory 404B. In aspects in which processor 402 includes two or more processors, the two or more processors may be included with the same computing device 400, or may be suitably separated among two or more computing devices 400. In aspects in which memory 404 includes two or more memories, the two or more memories may be included with the same computing device 400, or may be suitably separated among two or more computing devices 400. The computing device(s) 400 with which the two or more memories of memory 404 are included may be the same computing device(s) 400 with which the at least one processor of processor 402 is included or may be different. For example, a processor 402 may be included with a first computing device 400A (not shown) and a memory 404 may be included with a second computing device 400B (not shown), e.g., a server, in communication with the first computing device 400A over a network.

Memory 404 may store intrinsic parameters 406 of various cameras that are used in the present techniques. For example, memory 404 may store intrinsic parameters 406 of each of the cameras associated with image sensor configurations 500 and 510. Example intrinsic parameters 406 include a focal point, geometric lens distortion, scale factor, principal point, skew, or other suitable parameters based on a camera's internal configuration. Memory 404 may additionally or alternatively store one or more models that perform various aspects of the present techniques. For example, memory 404 may store a model 406. Model 406 may include one or more layers that are trained to perform one or more of: neural ray creation, neural ray ordering, graph network construction, and feature set determination.

For example, model 406 may be implemented as one or more machine learning models, including supervised learning models, unsupervised learning models, other types of machine learning models, and/or other types of predictive models. For example, model 406 may be implemented as one or more of a neural network, a transformer model, a decision tree model, a support vector machine, a Bayesian network, a classifier model, a regression model, and the like. Model 406 may be trained based on training data to determine a unified representation of all of the information captured by different cameras of a multi-camera setup. For example, one or more training datasets may be used that contain image frames captured by the various cameras of the multi-camera setup. The training data sets may specify one or more expected outputs. For example, an expected feature set, expected bounding boxes, or expected objects to be detected. Parameters of model 406 may be updated based on whether model 406 determines correct outputs when compared to the expected outputs. In particular, model 406 may receive one or more pieces of input data from the training data sets that are associated with a plurality of expected outputs. Model 406 may determine predicted outputs based on a current configuration of model 406. The predicted outputs may be compared to the expected outputs and one or more parameter updates may be computed based on differences between the predicted outputs and the expected outputs. In particular, the parameters may include weights (e.g., priorities) for different features and combinations of features (e.g., image features of a vehicle, pedestrian, stationary object, the sky, etc.). The parameter updates to model 406 may include updating one or more of the features analyzed and/or the weights assigned to different features or combinations of features (e.g., relative to the current configuration of model 406).

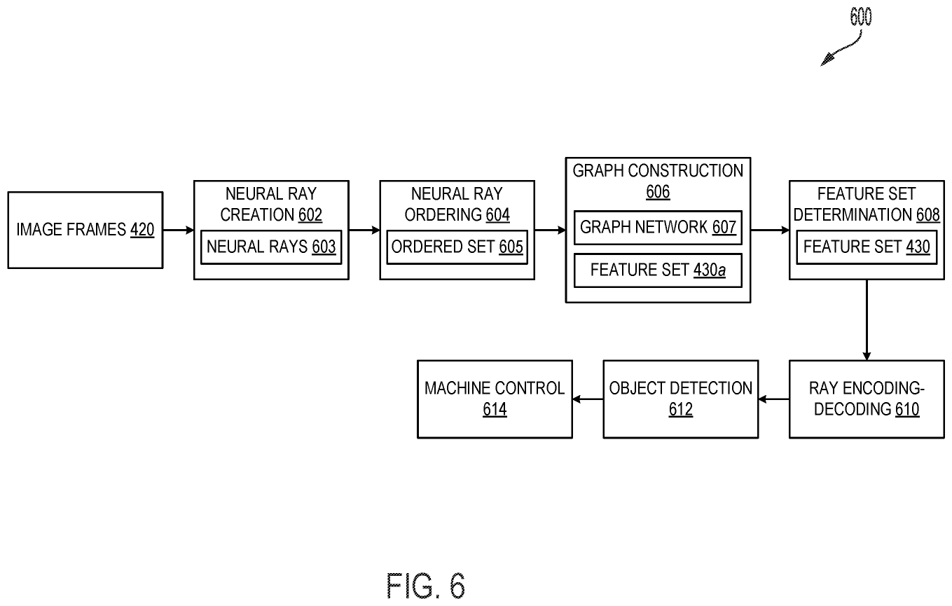

FIG. 6 is a flow diagram of an example pipeline 600 for determining a unified representation of all of the information captured by different cameras of a multi-camera setup, and in some aspects for object detection or machine control based on the unified representation. Pipeline 600 includes receiving image frames 420. As described above, image frames 420 may be received from a plurality of cameras (e.g., cameras 203 and 205) of a multi-camera setup, such as the cameras associated with image sensor configurations 500 and 510. Image frames 420 are used for neural ray creation 602. Neural ray creation 602 includes projecting each pixel of each image frame of image frames 420 onto a 3D space by using the intrinsic parameters (e.g., intrinsic parameters 406) of the respective cameras to create neural rays 603. In various aspects, neural ray creation 602 may be performed by model 406, such as by a layer of model 406. The projection process computes the 3D position of a pixel in the camera coordinate system, and the 3D position is represented as a 3D point (X,Y,Z). A neural ray of neural rays 603 is created by grouping a set of the 3D points on a line in the 3D space that originates at the camera center and terminates at a point representing a pixel that is farthest away from the camera center on the line. Stated differently, a neural ray is a line that extends from a camera center to a furthest point away from the camera center based on the pixel data and includes all of the 3D points along the line.

Neural ray ordering 604 includes ordering the neural rays 603 based on a parameter to determine an ordered set 605 of neural rays 603. In various aspects, neural ray ordering 604 may be performed by model 406, such as by a layer of model 406. As an example, the parameter may be an azimuth angle associated with a neural ray, though other suitable parameters may be used to order neural rays 603 such that neural rays 603 with similar characteristics are grouped together. As used herein, an azimuth angle is the angle between the projection of a neural ray on the xy-plane (defined by the positive x- and y-axes) and the positive x-axis. Ordering the neural rays 603 into the ordered set 605 creates groups of neural rays having a similar characteristic, which can assist object detection accuracy. For example, fisheye and pinhole cameras have large fields-of-view that enable capturing a wide range of azimuth angles, and by ordering the neural rays 603 based on azimuth angle, groups are formed in the ordered set 605 of neural rays that are close to each other in the 3D space and likely to be representing the same objects in a scene. Ordering the neural rays 603 by azimuth angle into the ordered set 605 also ensures that neural rays from different image frames taken by different cameras are aligned with each other, which contributes to determining a complete and accurate representation of a scene that is more robust to noise and occlusions. In another example, the distortion introduced by a fisheye lens can make it difficult to accurately estimate the positions of objects in a scene, but ordering the neural rays 603 into the ordered set 605 can group neural rays that are likely to have similar distortion characteristics, which can contribute to feature consistency and reduced data noise.

Continuing the azimuth angle example as the parameter for ordering, the 3D points representing each of the pixels of image frames 420 may be converted to spherical coordinates (ρ, θ, ϕ) in which ρ is the distance from the camera center to the pixel, θ is the azimuth angle, and ϕ is the elevation angle. An example process to determine the azimuth angle of a neural ray is as follows, though is not intended to be limiting. The neural ray's direction vector in 3D space is first determined. Given a point of the neural ray in the image plane, the point's 3D coordinates on the unit sphere can be determined by unprojecting the point onto a 3D point using camera intrinsic parameters 406 and then normalizing the 3D point to the unit sphere. Denoting the 3D point as P=(x, y, z), then the neural ray's direction vector d passing through the point P can be determined according to Equation 1 below.

$$d = ( x , y , z ) / \sqrt{( {x}^{2} + {y}^{2} + {z}^{2} )} \qquad ( 1 )$$

The neural ray's azimuth angle can then be determined by first projecting the neural ray's direction vector onto the xy-plane by setting the direction vector's z-component to zero. The azimuth angle can then be determine according to Equation 2 below in which pₓ and p_{y} are the x and y coordinates, respectively, of the point on the image plane that the neural ray passes through after projection. In Equation 2, p_{y} may be positive or negative. When p_{y} is positive, the azimuth angle is equal to 0. When p_{y} is negative, the azimuth angle is equal to 2π−θ. For instance, the azimuth angle may be defined in the range [0, 2π], where 0 corresponds to the positive x-axis and π/2 correspond to the positive y-axis.

$$θ = arccos ( {p}_{x} / \sqrt{( {p}_{x}^{2} + {p}_{y}^{2} )} \qquad ( 2 )$$

Graph network construction 606 involves creating a graph network 607 (e.g., a graph neural network) that represents each neural ray as a sequence of points, which are each associated with a node of the graph network 607.

In various aspects, graph network construction 606 may be performed by model 406, such as by a layer of model 406. For each neural ray of the ordered set 605 of neural rays 603, a fixed number of points along the neural ray's length are selected and each point becomes a node in the graph network 607. In various aspects, the points along the neural ray's length are equidistant from one another. In at least some aspects, edges of the graph network 607 are determined based on spatial proximity between two nodes. For example, in such aspects, two nodes are connected by an edge if the Euclidian distance between the points corresponding to the two nodes is within a certain threshold distance. Stated differently, if the Euclidian distance between two points corresponding to two nodes is less than (e.g., fails to meet) a threshold value, then an edge is created between the two nodes in the graph network 607. Otherwise, no edge is created. The graph network 607 can connect points along and across neural rays 603 based on spatial proximity, which encodes the 3D structure of the scene and relationships between points on different neural rays 603. For example, when the features are ordered based on the azimuth angle of neural rays 603, adjacency in the feature array correlates with neural ray 603 proximity in 3D space, which provides useful inductive biases. Additionally, in the example of graph network 607 being a graph neural network, a graph neural network takes advantage of the inherent locality of the data provided to the graph neural network. Determining the ordered set 605 of neural rays 603 thereby enables efficiently applying a graph neural network to the neural rays 603. Applying graph network 607 allows learning features that aggregate information from neighboring points, which results in features that are robust to noise/occlusions and incorporate 3D context.

Graph network construction 606 of graph network 607 determines an initial feature set 430a as an output of this stage of pipeline 600. Constructing graph network 607 from neural rays 603 provides an initial feature for each 3D point along neural rays 603, and these initial features together form an ordered unified feature set 430a representing an early fusion of information from all the image frames 420, encoded in a unified graph-based representation. Initial feature set 430a fuses information from all image frames 420 in the raw pixel/ray space, without any loss of information that would occur from using a CNN feature extractor, which allows preserving full details from all cameras.

Feature set determination 608 involves refining the initial feature set 430a to determine feature set 430. In at least some aspects, an attention mechanism is used to refine feature set 430a. For instance, the features of feature set 430a are updated by aggregating information from neighboring points based on the structure of graph network 607 and attention coefficients. For example, feature set determination 608 may involve applying graph attention networks (GAT) to initial feature set 430a to determine feature set 430. A GAT operation allows for the node representations of graph network 607 to be updated in a graph-specific manner by taking into account the internode relationships encoded in graph network 607. The GAT operation determines an attention coefficient for each edge in the graph network 607, which determines how much importance to assign to the neighboring nodes. The updated node representation is then a weighted sum of the neighboring node features, where the weights are the attention coefficients. In some aspects, the attention coefficients may be determined by computing a linear combination of the node features, applying an activation function, and taking the softmax of the resulting values over the neighboring nodes. After a fixed number of GAT layers, the feature set 430 can be obtained. The updated features of feature set 430 encode richer contextual information than feature set 430a via graph message passing, while retaining the inductive biases of the ordered representation of neural rays 603, which strikes a balance between local and global information.

Stated differently, the node features of 430a get updated by aggregating information from spatially nearby points along and across neural rays 603, which allows each point to incorporate contextual 3D information. The attention mechanism allows learning to focus on the most relevant neighboring points, which provides more discriminative features. The updated features of feature set 430 encode both local point information as well as neighborhood context due to the message passing. Additionally, the features of feature set 430 retain their ordering (e.g., based on azimuth angle of neural rays 603), preserving the coherence with 3D space. The number of features per node is also fixed, thereby providing a consistent dimensionality for downstream processing. In this way feature set 430 may serve as a strong foundation for downstream 3D perception tasks.

It will be appreciated that, in some aspects, feature set 430a may be passed to downstream 3D perception tasks without first being refined with an attention mechanism.

In some aspects, pipeline 600 may further include providing the feature set 430 to a transformer network (e.g., an encoder-decoder network) for ray encoding-decoding 610. Ray encoding-decoding 610 involves extracting meaningful features from the node features along each neural ray in the feature set 430. In this way, meaningful 3D features are extracted from the unordered and unstructured input data associated with image frames 420 that allow for accurate predictions for object detection and localization in 3D space. For example, in some aspects, pipeline 600 may further include object detection 612 that involves detecting an object based on the features extracted by the encoder-decoder network.

In various aspects, pipeline 600 includes machine control 614 which involves controlling a vehicle or other machine (e.g., robot) based on the feature set 430, and more particularly based on the object(s) detecting during object detection 612. For example, the feature set 430 may be input to a vehicle's driving assistance system that processes the feature set 430 to control functions of the vehicle.

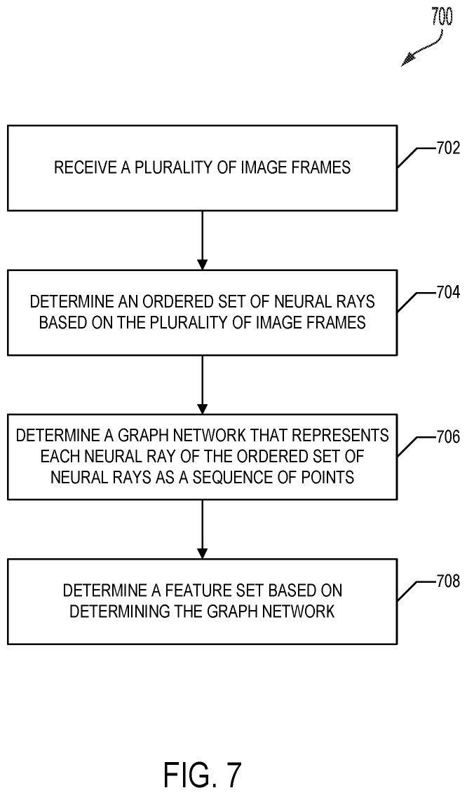

One method of performing image processing according to embodiments described above is shown in FIG. 7. FIG. 7 is a flow chart illustrating an example method 700 for determining a feature set that represents features from all image frames received from a multi-camera setup. Method 700 includes, at block 702, receiving a plurality of image frames (e.g., image frames 420). The image frames 420 may be received from a plurality of image sensors (e.g., image sensors 502 to 522) of a plurality of cameras including, e.g., first camera 203 and second camera 205. In at least some aspects, image frames 420 represent a 360-degree view of a scene surrounding the plurality of cameras.

At block 704, an ordered set (e.g., ordered set 605) of neural rays (e.g., neural rays 603) is determined based on the image frames 420. Each neural ray of the ordered set 605 of neural rays 603 represents three-dimensional positions of pixels of an image frame of the image frames 420. For example, determining the ordered set 605 of neural rays 603 may include projecting each pixel of the image frames 420 onto a three-dimensional space based on intrinsic parameters (e.g., intrinsic parameters 406) of a plurality of cameras (e.g., including first camera 203 and second camera 205) from which the image frames 420 are received. The neural rays 603 are organized into the ordered set 605 based on a parameter. For example, the parameter may be a respective azimuth angle associated with each of the neural rays 603. In such aspects, method 700 may include determining the respective azimuth angle associated with each of the neural rays 603. Determining the respective azimuth angle may be based on intrinsic parameters 406 of the plurality of cameras used to capture the image frames 420.

At block 706, a graph network (e.g., graph network 607) is determined that represents each neural ray of the ordered set 605 of neural rays 603 as a sequence of points. Each point in the sequence of points is associated with a node of a plurality of nodes of the graph network 607. In an example, the graph network 607 is a graph neural network. In various aspects, the sequence of points associated with a respective neural ray include equidistant points along a length of the respective neural ray. The graph network 607 may include a plurality of edges that each connect two respective nodes. For example, a first node and a second node are connected by an edge when a Euclidian distance between the first node and the second node fails to meet a threshold. In another example, a third node and a fourth node are not connected by an edge when the Euclidian distance between the third node and the fourth node meets the threshold.

At block 708, a feature set (e.g., feature set 430a or 430) is determined, based on determining the graph network 607, for processing by a transformer network (e.g., encoder-decoder network of ray encoding-decoding 610). The feature set 430a, 430 combines features, of each of the image frames 420, that are represented by the ordered set 605 of neural rays 603. Stated differently, feature set 430a, 430 is a unified representation of all of the features associated with all of the cameras in the multi-camera setup based on the graph network 607, which represents the neural rays 603, which represent the pixels of image frames 420. In some aspects, the feature set 430a, 430 is determined based graph attention networks. For example, the feature set 430 may be determined by applying a graph attention networks operation to feature set 430a that is determined based on determining graph network 607.

In various aspects, method 700 may include detecting an object based on the feature set 430. For example, the transformer network may process the feature set 430 to extract meaningful features from the feature set 430 so that one or more bounding boxes can be determined, which may be used for detecting an object.

In various aspects, method 700 may include controlling a vehicle or other machine (e.g., robot) based on the feature set 430. For example, the feature set 430 may be input to a vehicle's driving assistance system that processes the feature set 430 to control functions of the vehicle. For example, the feature set 430 may be processed to detect objects and the vehicle's functions may be controlled based on the objects detected.

It is noted that one or more blocks (or operations) described with reference to FIG. 6 or 7 may be combined with one or more blocks (or operations) described with reference to another of the figures. For example, one or more blocks (or operations) of FIG. 6 or 7 may be combined with one or more blocks (or operations) of FIGS. 1-3. As another example, one or more blocks associated with FIG. 6 or 7 may be combined with one or more blocks associated with FIG. 4. As another example, one or more blocks associated with FIG. 7 may be combined with one or more blocks associated with FIG. 6.

In one or more aspects, techniques for supporting vehicular operations may include additional aspects, such as any single aspect or any combination of aspects described below or in connection with one or more other processes or devices described elsewhere herein. In a first aspect, an apparatus is configured to perform operations including receiving a plurality of image frames; determining an ordered set of neural rays based on the plurality of image frames; determining a graph network that represents each neural ray of the ordered set of neural rays as a sequence of points; and determining, based on determining the graph network, a feature set for processing by a transformer network. Each neural ray of the ordered set of neural rays represents three-dimensional positions of pixels of an image frame of the plurality of image frames, each point is associated with a node of a plurality of nodes of the graph network, and the feature set includes features of each of the plurality of image frames. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, determining the ordered set of neural rays includes projecting each pixel of the plurality of image frames onto a three-dimensional space based on intrinsic parameters of a plurality of cameras from which the plurality of image frames are received.

In a third aspect, in combination with one or more of the first aspect or the second aspect, the neural rays in the ordered set of neural rays are ordered based on a respective azimuth angle associated with each of the neural rays.

In a fourth aspect, in combination with the third aspect, the operations further include determining the respective azimuth angle associated with each of the neural rays.

In a fifth aspect, in combination with the fourth aspect, determining the respective azimuth angle is based on intrinsic parameters of a plurality of cameras used to capture the plurality of image frames.

In a sixth aspect, in combination with one or more of the first aspect through the fifth aspect, the plurality of image frames are received from a plurality of different types of cameras.

In a seventh aspect, in combination with one or more of the first aspect through the sixth aspect, the sequence of points associated with a respective neural ray include equidistant points along a length of the respective neural ray.

In an eighth aspect, in combination with one or more of the first aspect through the seventh aspect, a Euclidian distance between a first node of the plurality of nodes of the graph network and a second node of the plurality of nodes of the graph network fails to meet a threshold, and the first node and the second node are connected by an edge.

In a ninth aspect, in combination with one or more of the first aspect through the eighth aspect, the feature set is determined based on graph attention networks.

In a tenth aspect, in combination with one or more of the first aspect through the ninth aspect, the operations further include detecting an object based on the feature set; and controlling a function of a machine based on the object detected.

In an eleventh aspect, in combination with one or more of the second aspect through the tenth aspect, a vehicle includes a plurality of cameras that together have a field of view spanning around the vehicle, at least one processor, and a memory coupled to the at least one processor. The at least one processor is configured to perform operations including receiving, from the plurality of cameras, a plurality of image frames; determining an ordered set of neural rays based on the plurality of image frames and intrinsic parameters of the plurality of cameras; determining a graph network that represents each neural ray of the ordered set of neural rays as a sequence of points; and determining, based on determining the graph network, a feature set for processing by a transformer network. Each neural ray of the ordered set of neural rays represents three-dimensional positions of pixels of an image frame of the plurality of image frames, each point is associated with a node of a plurality of nodes of the graph network, and the feature set includes features of each of the plurality of image frames.

In a twelfth aspect, in combination with the eleventh aspect, determining the ordered set of neural rays includes projecting each pixel of the plurality of image frames onto a three-dimensional space based on the intrinsic parameters of the plurality of cameras.

In a thirteenth aspect, in combination with one or more of the eleventh aspect through the twelfth aspect, the plurality of cameras include a plurality of different types of cameras, and the plurality of image frames are received from the plurality of different types of cameras, and wherein the feature set is determined based on graph attention networks.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for image processing, comprising:
receiving a plurality of image frames;
determining an ordered set of neural rays based on the plurality of image frames, wherein each neural ray of the ordered set of neural rays represents three-dimensional positions of pixels of an image frame of the plurality of image frames;
determining a graph network that represents each neural ray of the ordered set of neural rays as a sequence of points, wherein each point is associated with a node of a plurality of nodes of the graph network; and
determining, based on determining the graph network, a feature set for processing by a transformer network, wherein the feature set includes features of each of the plurality of image frames.

2. The method of claim 1, wherein determining the ordered set of neural rays includes projecting each pixel of the plurality of image frames onto a three-dimensional space based on intrinsic parameters of a plurality of cameras from which the plurality of image frames are received.

3. The method of claim 1, wherein the neural rays in the ordered set of neural rays are ordered based on a respective azimuth angle associated with each of the neural rays.

4. The method of claim 3, further comprising determining the respective azimuth angle associated with each of the neural rays.

5. The method of claim 4, wherein determining the respective azimuth angle is based on intrinsic parameters of a plurality of cameras used to capture the plurality of image frames.

6. The method of claim 1, wherein the plurality of image frames are received from a plurality of different types of cameras.

7. The method of claim 1, wherein the sequence of points associated with a respective neural ray include equidistant points along a length of the respective neural ray.

8. The method of claim 1, wherein a Euclidian distance between a first node of the plurality of nodes of the graph network and a second node of the plurality of nodes of the graph network fails to meet a threshold, and wherein the first node and the second node are connected by an edge.

9. The method of claim 1, wherein the feature set is determined based on graph attention networks.

10. The method of claim 1, further comprising:
detecting an object based on the feature set; and
controlling a function of a machine based on the object detected.

11. An apparatus, comprising:
a memory storing processor-readable code; and
at least one processor coupled to the memory, the at least one processor configured to execute the processor-readable code to cause the at least one processor to perform operations including:
receiving a plurality of image frames;
determining an ordered set of neural rays based on the plurality of image frames, wherein each neural ray of the ordered set of neural rays represents three-dimensional positions of pixels of an image frame of the plurality of image frames;
determining a graph network that represents each neural ray of the ordered set of neural rays as a sequence of points, wherein each point is associated with a node of a plurality of nodes of the graph network; and
determining, based on determining the graph network, a feature set for processing by a transformer network, wherein the feature set includes features of each of the plurality of image frames.

12. The apparatus of claim 11, wherein determining the ordered set of neural rays includes projecting each pixel of the plurality of image frames onto a three-dimensional space based on intrinsic parameters of a plurality of cameras from which the plurality of image frames are received.

13. The apparatus of claim 11, wherein the neural rays in the ordered set of neural rays are ordered based on a respective azimuth angle associated with each of the neural rays.

14. The apparatus of claim 13, further comprising determining the respective azimuth angle associated with each of the neural rays.

15. The apparatus of claim 14, wherein determining the respective azimuth angle is based on intrinsic parameters of a plurality of cameras used to capture the plurality of image frames.

16. The apparatus of claim 11, wherein the plurality of image frames are received from a plurality of different types of cameras.

17. The apparatus of claim 11, wherein the sequence of points associated with a respective neural ray include equidistant points along a length of the respective neural ray.

18. The apparatus of claim 11, wherein a Euclidian distance between a first node of the plurality of nodes of the graph network and a second node of the plurality of nodes of the graph network fails to meet a threshold, and wherein the first node and the second node are connected by an edge.

19. The apparatus of claim 11, wherein the feature set is determined based on graph attention networks.

20. The apparatus of claim 11, further comprising:
detecting an object based on the feature set; and
controlling a function of a machine based on the object detected.

21. A non-transitory computer-readable medium storing instructions that, when executed by a processing system that includes one or more processors, cause the processing system to perform operations comprising:
receiving a plurality of image frames;
determining an ordered set of neural rays based on the plurality of image frames, wherein each neural ray of the ordered set of neural rays represents three-dimensional positions of pixels of an image frame of the plurality of image frames;
determining a graph network that represents each neural ray of the ordered set of neural rays as a sequence of points, wherein each point is associated with a node of a plurality of nodes of the graph network; and
determining, based on determining the graph network, a feature set for processing by a transformer network, wherein the feature set includes features of each of the plurality of image frames.

22. The non-transitory, computer-readable medium of claim 21, wherein determining the ordered set of neural rays includes projecting each pixel of the plurality of image frames onto a three-dimensional space based on intrinsic parameters of a plurality of cameras from which the plurality of image frames are received.

23. The non-transitory, computer-readable medium of claim 21, wherein the neural rays in the ordered set of neural rays are ordered based on a respective azimuth angle associated with each of the neural rays.

24. The non-transitory, computer-readable medium of claim 21, wherein the plurality of image frames are received from a plurality of different types of cameras.

25. The non-transitory, computer-readable medium of claim 21, wherein the feature set is determined based on graph attention networks.

26. A vehicle, comprising:
a plurality of cameras that together have a field of view spanning around the vehicle; and
a memory storing processor-readable code; and
at least one processor coupled to the memory, the at least one processor in communication with the plurality of cameras and configured to execute the processor-readable code to cause the at least one processor to perform operations including:
receiving, from the plurality of cameras, a plurality of image frames;
determining an ordered set of neural rays based on the plurality of image frames and intrinsic parameters of the plurality of cameras, wherein each neural ray of the ordered set of neural rays represents three-dimensional positions of pixels of an image frame of the plurality of image frames;
determining a graph network that represents each neural ray of the ordered set of neural rays as a sequence of points, wherein each point is associated with a node of a plurality of nodes of the graph network; and
determining, based on determining the graph network, a feature set for processing by a transformer network, wherein the feature set includes features of each of the plurality of image frames.

27. The vehicle of claim 26, wherein determining the ordered set of neural rays includes projecting each pixel of the plurality of image frames onto a three-dimensional space based on the intrinsic parameters of the plurality of cameras.

28. The vehicle of claim 26, wherein the neural rays in the ordered set of neural rays are ordered based on a respective azimuth angle associated with each of the neural rays.

29. The vehicle of claim 26, wherein the plurality of image frames are received from a plurality of different types of cameras, and wherein the feature set is determined based on graph attention networks.

30. The vehicle of claim 26, further comprising:
detecting an object based on the feature set; and
controlling a function of the vehicle based on the object detected.
